(19) United States
(12) Patent Application Publication
(10) Pub. No.: US 2009/0320319 A1
(43) Pub. Date: Dec. 31, 2009

(54) Domestic Device For The Care of Laundry Items and Method for Passing Cooling Air Into Such a Device

(75) Inventors: Klaus Grunert, Berlin (DE); Günter Steffens, Dallgow-Döberitz (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, München (DE)

(21) Appl. No.: 12/308,843

(22) PCT Filed: Jun. 20, 2007
(86) PCT No.: PCT/EP2007/056113

§ 371 Date: Dec. 22, 2008

(30) Foreign Application Priority Data
Jul. 6, 2006 (DE) 10 2006 031 353.4

(51) Int. Cl. F26B 3/02; D06F 58/04; F26B 21/12

(52) U.S. Cl. 34/467; 34/132; 34/570

(57) ABSTRACT

A domestic appliance for the care of laundry items is provided a housing, a container housed by the housing and operable to accommodate laundry items, a process air loop, a heat exchanger operable to dehumidify process air exiting the container, a heater operable to heat process air, and a cooling air loop for conveying cooling air from an ambient environment of the domestic appliance into contact with the heat exchanger to thereby cool the heat exchanger, the cooling air loop including an air channeling device that is operable to selectively: a) directly vent at least some of the cooling air fed to the heat exchanger from the domestic appliance to the ambient environment and b) channel at least some of the cooling air fed to the heat exchanger into the domestic appliance for passage thereafter out of openings in the domestic appliance to the ambient environment.

The invention relates to a domestic appliance for the care of laundry items, comprising a housing wherein are disposed a container for accommodating laundry items, a process air loop which is connected to the container, process air flowing through said container, a heat exchanger which is connected to the process air loop and is designed to dehumidify the process air emerging from the container, a heater which is connected to the process air loop and is designed to heat up the process air, and a cooling air loop for channeling cooling air from an ambient environment of the appliance for cooling the heat exchanger.

The term “process air loop” denotes in particular a closed process air circuit as provided in a circulating air dryer. In general, the term “domestic appliance for the care of laundry items” encompasses any such appliance designed to dry laundry, in particular a tumble dryer or a washer dryer. In the following, the process air loop shall comprise, in particular, an air duct, a blower and other components through which process air flows during operation; similarly, the cooling air loop shall comprise, in particular, an air duct, a blower and other components through which cooling air flows during operation.

For a conventional domestic appliance of the generic type mentioned in the introduction, in particular a conventional tumble dryer, energy management during operation is relatively inadequate. On the one hand, a tumble dryer requires a minimum amount of energy to dry a given laundry item of normal moisture content (as produced after washing/spinning in a conventional washing machine). Less than this minimum amount is required if the dryer contains a heat pump enabling it to recover at least some of the energy expended in evaporating moisture. On the other hand, with a convention tumble dryer, whether with or without heat pump, there is an energy requirement over and above the minimum because of additional heat leakages which are always present to a greater or lesser extent.

The object of the present invention is therefore to create a domestic appliance for the care of laundry items which enables energy management during operation to be improved. The object of the present invention is also to create a method for improving the cooling air loop in terms of better energy management in a domestic appliance for the care of laundry items.

This object is achieved by a domestic appliance having the features set forth in claim 1, and a method having the features set forth in claim 14. Preferred developments of the domestic appliance and of the method are detailed in the dependent claims and claim 15 respectively.

An inventive domestic appliance for the care of laundry items, comprising a housing wherein are disposed a container for accommodating laundry items, a process air loop which is connected to the container, process air flowing through said container, a heat exchanger which is connected to the process air loop and is designed to dehumidify the process air leaving the container, a heater which is connected to the process air loop and is designed to heat up the process air, and a cooling air loop for channeling cooling air from an ambient environment of the appliance for cooling the heat exchanger, is characterized by an air channeling device which is disposed in the cooling air loop and can be set such that optionally:

a) at least some of the cooling air fed to the heat exchanger can be vented directly from the appliance to the ambient environment; and

b) at least some of the cooling air fed to the heat exchanger can be channeled into the appliance and returned to the ambient environment through slits in the housing.

This allows optimum energy management of the appliance as a function of the operating state. The heat developed in the process air flow during a drying process can therefore be dissipated on a phase-dependent basis or at least some of it can be re-used in the appliance itself.

A preferred development of the appliance is characterized in that the air channeling device can be set such that, as an additional option, essentially no cooling of the heat exchanger takes place. Particularly when the appliance is started up, this enables rapid heating of the functional components of the appliance to be achieved and undesirable heat losses to be prevented in such an operating phase.

The air channeling device is preferably disposed downstream of the heat exchanger.

The air channeling device preferably comprises a valve device which is designed to at least partially block or unblock air outlets to the corresponding cooling air duct. Therefore, there is preferably required only one air channeling device and, in particular, only one valve device in order to allow situation-dependent and demand-driven channeling of cooling air as a function of the current operating phase. This enables the appliance's component count to be minimized and the individual channeling of the cooling air to be designed in a low-cost and relatively simple manner.

The different air outlets preferably feed into a common nodal point or into a common intersection at which the valve device is advantageously disposed. The entire concept relating to optimum channeling of cooling air in different phases of operation can therefore be implemented in a space-saving and also locally compact manner, thereby enabling e.g. repair, replacement and maintenance of the air channeling device to be carried out at low cost.

The appliance preferably has a control unit which is designed to control the valve device, said valve device preferably being controlled on a time-dependent and/or temperature-dependent basis.

The appliance preferably comprises a first temperature measuring unit which is designed and correspondingly disposed to measure the temperature of the laundry items in the container, the valve device being controllable by the control unit as a function of this laundry item temperature. It can alternatively or additionally be provided that the appliance has a second temperature measuring unit which is designed to measure the temperature of the cooling air downstream of the heat exchanger, the valve device being controllable by the control unit as a function of this temperature. At least one of the temperature measuring units is preferably a temperature sensor. It can also be provided that at least one of the temperature measuring units, preferably both temperature measuring units, be implemented as a thermostat.

A cooling air blower is preferably incorporated in the cooling air loop in the appliance, the air channeling device being disposed adjacent to the cooling air blower. The nodal point at which the air outlets are brought together is preferably disposed in the vicinity of the cooling air blower.

In addition, the appliance preferably comprises a process air blower by means of which the process air in the process air loop can be conveyed in a flow direction. The process air loop and the cooling air loop are implemented as separate systems, the heat exchanger preferably being implemented as a cross-flow heat exchanger.

The appliance preferably comprises a drive unit, in particular a motor, which is designed to drive the container and the cooling air blower as well as the process air blower. Providing a single motor for driving these three components makes for a low-cost design.

Three operating phases of the appliance and therefore also of the drying process during circulation of the process air by the process air loop with simultaneous heating of the process air by means of the heater are identified: a heating phase which characterizes the first drying phase or first operating phase, a steady-state phase which characterizes a second drying phase or second operating phase, and an end phase which characterizes a third drying phase or third operating phase. In the first operating phase, i.e. the heating phase, it is preferable to release as little energy as possible to the ambient environment of the appliance. In this phase it is therefore particularly efficient for appliance energy management if essentially no cooling of the heat exchanger is effected and the air channeling device is set accordingly, thereby in particular enabling the heat exchanger to heat up in this phase. In the steady-state phase, i.e. the second operating phase, the heat exchanger is essentially operating under optimum conditions. It has heated up and cooling is carried out to condense moisture from the process air, the air channeling device being set appropriately for this purpose in this phase. The cooling air that has flowed round and/or through the heat exchanger has been heated by the heat exchanger, but is not yet warm enough to enable the energy balance in the appliance to be improved by using it. In this phase it is therefore advantageous to channel at least some, if not all, of this heated cooling air from the appliance to the ambient environment. In the end phase, i.e. the third operating phase, the cooling air that has flowed around and/or through the heat exchanger is warm enough for it to be usefully employed to improve the energy balance inside the appliance, and it can therefore be advantageously channeled e.g. to the outer wall or rather the surface of the container accommodating the laundry items. Once again, the air channeling device is set accordingly. In addition, in this third operating phase, the heated cooling air can also be channeled to other components, particularly plastic parts inside the appliance, in order to supply corresponding thermal energy also thereto and improve energy management. To complete the drying process, i.e. as the final step of the method (fourth operating phase), the previously continuously or intermittently used heater is switched off, so that the process air flow, the appliance and the dried load can be cooled down, it being advantageous to use the heat exchanger for cooling down by again removing from the appliance the cooling air that continues to be fed through the heat exchanger.

The appliance can have a heat pump which is implemented in particular as a Peltier heat pump. In a Peltier heat pump design, two heat exchangers are then provided, one of which is in contact with a cold side of a Peltier module and the other with a hot side of the Peltier module.

An inventive method for channeling cooling air in a domestic appliance for the care of laundry items comprising a housing wherein are disposed a container for accommodating laundry items, a process air loop which is connected to the container, process air flowing through said container, a heat exchanger which is connected to the process air loop and is designed to dehumidify the process air leaving the container, a heater which is connected to the process air loop and is designed to heat up the process air, and a cooling air loop for channeling cooling air from the ambient environment of the appliance for cooling the heat exchanger, an air channeling device being disposed in the cooling air loop and adjustable such that optionally:

a) at least some of the cooling air fed to the heat exchanger can be vented directly from the appliance to the ambient environment; and

b) at least some of the cooling air fed to the heat exchanger can be channeled into the appliance and returned to the ambient environment through slits in the housing, is characterized in that process air is circulated through the process air loop and heated by means of the heater, and the air channeling device is initially set such that the cooling air fed to the heat exchanger is vented directly from the appliance to the ambient environment, and is then set such that the cooling air fed to the heat exchanger is channeled into the appliance and through the slits to the ambient environment, and finally dehumidification is terminated by terminating the heating of the process air.

This allows situation-dependent channeling of the cooling air in the appliance in respect of improved energy management during operation and in particular during the drying process of the laundry items.

A preferred embodiment of the method according to the invention in an appliance wherein there is disposed in the cooling air loop an air channeling device which can be set such that optionally:

a) essentially no cooling of the heat exchanger takes place;

b) at least some of the cooling air fed to the heat exchanger can be vented directly from the appliance to the ambient environment; and

c) at least some of the cooling air fed to the heat exchanger can be channeled into the appliance and returned to the ambient environment through slits in the housing, is characterized in that process air is circulated by the process air loop and heated by means of the heater, and the air channeling device is initially set such that, for the purpose of heating the appliance, no cooling of the heat exchanger takes place, is then set such that the cooling air fed to the heat exchanger is vented directly from the appliance to the ambient environment, and is subsequently set such that the cooling air fed to the heat exchanger is channeled into the appliance and through slots to the ambient environment, and finally dehumidification is terminated by terminating the heating of the process air.

For the method according to one of these embodiments it is preferred that, to terminate dehumidification, the air channeling device is set such that the cooling air fed to the heat exchanger is vented directly from the appliance to the ambient environment. The advantage of this is that the heat exchanger is used for rapid cooling of the appliance and of the dried laundry items.

Preferred embodiments of the method correspond in each case to preferred embodiments of the appliance, and vice versa.

An exemplary embodiment of the invention will now be explained in greater detail with reference to a schematic drawing.

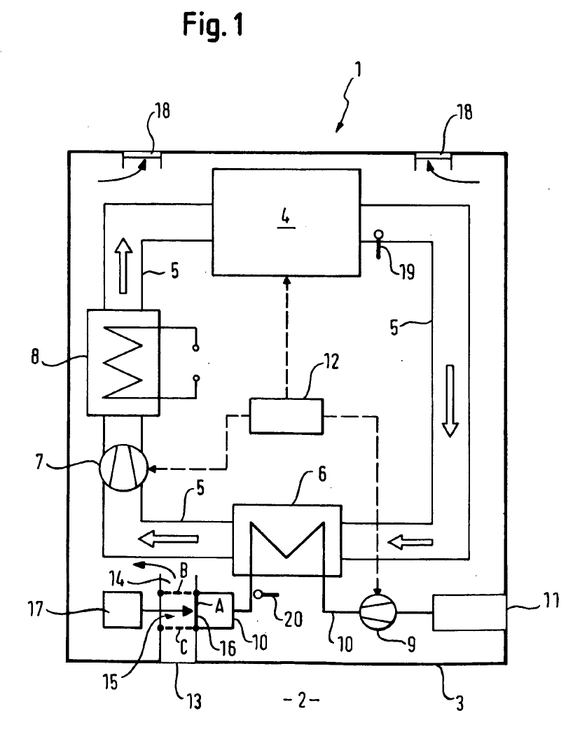

FIG. 1 is a simplified block diagram showing an appliance 1 for the care of laundry items which is implemented as a tumble dryer 1. The tumble dryer 1 is designed as a circulating air dryer, and only those components essential for understanding the following embodiments are shown in FIG. 1. The tumble dryer 1 is in an ambient environment 2 from which it is separated by a housing 3, the dryer 1 having a drum 4 or container 4 for accommodating laundry items which is disposed in a process air loop 5. The process air loop 5 is basically implemented as a closed process air circuit 5. The tumble dryer 1 additionally comprises a heat exchanger 6 which is disposed in the process air loop 5 and is designed to dehumidify the process air leaving the container 4, said process air flowing in the process air loop 5 in the direction indicated by the arrows. For the sake of clarity, details of the removal of the condensate accumulating in the heat exchanger 6 and having to be separated from the process air are not shown. A process air blower 7 is provided to circulate process air in the process air loop 5. A heater 8 in the process air loop 5 is used to heat the process air before it enters the drum 4.

To cool the heat exchanger 6, the tumble dryer 1 comprises a cooling air blower 9 which is disposed in a cooling air loop 10. The cooling air blower 9 is located upstream of the heat exchanger 6. During operation of the appliance 1, the cooling air blower draws in air from the ambient environment 2 through an air inlet 11 and passes it via the cooling air loop 10 through the heat exchanger 6. The process air loop 5 and the cooling air loop 10 are separate air guiding systems, some of the cooling air loop 10 being only schematically illustrated. The heat exchanger 6 is implemented as a cross-flow heat exchanger 6.

The tumble dryer 1 additionally comprises a drive unit 12 (only shown schematically), namely an electric motor 12 which is designed to drive both the drum 2 and the cooling air blower 9 and process air blower 7.

The tumble dryer 1 also comprises a first air outlet 13 through which cooling air can be discharged directly from the cooling air loop 10 into the ambient environment 2. Cooling air can be discharged from the cooling air loop into the interior of the housing 3 through a second air outlet 14. The air outlets 13 and 14 open into the cooling air loop 10 at a common nodal point 15.

In this nodal point 15 there is disposed an air channeling device 16, 17 comprising a valve device 16 which is implemented as a three-way flap 16. The valve device 16 is connected to a control device 17 for controlling the air channeling device 16, 17.

The valve device 16 is controlled by the control unit 17 on a time-dependent and/or temperature-dependent basis, time-dependent control taking place as a function of a time progression of a drying process of the tumble dryer 1. Temperature-dependent control preferably takes place as a function of a measured instantaneous temperature of the laundry items in the container 2 and/or as a function of the cooling air temperature measured after it has flowed around and/or through the heat exchanger 6.

During operation of the tumbler dryer 1 and therefore during the drying process of the laundry items in the container 4, the heater 8 is in operation essentially continuously, albeit intermittently depending on the design of the appliance 1 for the purpose of regulating the heat supplied as well as the temperature in the process air. This constitutes a first operating phase which is termed the heating phase and in which, in respect of the heat balance in the tumbler dryer 1 and therefore of its energy management, as little energy as possible shall be dissipated to the ambient environment 2 and therefore to the outside. In this first operating phase, the valve device 16 is controlled such that it closes the nodal point 15 so that the air outlets 13 and 14 are blocked and cooling air cannot therefore pass thereinto. The valve device 16 in FIG. 1 is shown in this position. In the first operating phase, even with the cooling air blower 9 running, virtually no cooling air flow is generated, as the cooling air blower 9 employing the suction principle can produce no through-flow of air because of the closed valve device 16. The position of the valve device 16 in this first operating phase is characterized by position A (solid line). In this phase the heat exchanger 6 heats up without any appreciable condensation of moisture taking place.

As the drying process continues, another drying phase or second operating phase is reached in which the heat exchanger 6 is essentially operated at optimum level and condenses moisture out of the process air flow. In this phase the valve device 11a is controlled such that it goes from position A to position B, thereby only blocking the air outlet 14. Because of the thereby created opening in the nodal point 10, a cooling air flow is therefore produced by the running cooling air blower 9 and cooling of the heat exchanger 6 is achieved, the cooling air flowing through it being heated but not enough downstream of the heat exchanger 6 for it to be of further meaningful use in the tumble dryer 1 in respect of improving the heat balance. It is therefore advantageous, in this second operating phase, to vent this heated cooling air through the air outlet 13 to the ambient environment 2.

As the drying process continues further, a third operating phase or third drying phase, the end phase, is attained. In this phase the heat exchanger 6 has heated up further, causing the cooling air to heat up more strongly. After flowing through the heat exchanger 6, the cooling air is so hot that it can be used to improve the heat balance in the tumble dryer 1 and is therefore passed into the interior of the tumbler dryer 1. For this purpose the valve device 16 is controlled such that it goes from state/position B to position C, thereby causing the air outlet 13 to be closed, and the heated cooling air is fed via the air outlet 14 into the housing 3 where it can flow around all the components located therein. In doing so, it supplies heat, thus compensating for heat leakages and improves the energy balance of the tumbler dryer 1. This cooling air is finally returned to the ambient environment 2 through slits 18 in the housing 3, which slits 18 are normally located in a backpanel of the housing 3, which backpanel is not readily visible to a user of the tumble dryer 1.

To complete the drying process or method (fourth operating phase), the previously continuously or intermittently used heater 8 is switched off so that the process air, the tumble dryer 1 as a whole and the dried load in the drum 4 can cool down, it being advantageous to use the heat exchanger 6 for cooling down by passing the cooling air which continues to flow through it into the ambient environment 2 of the tumble dryer 1 in the manner described.

A first temperature measuring unit 19 measures the temperature of the process air stream flowing out of the drum 4, and therefore the temperature of the laundry items in the drum 4. A second temperature measuring unit 20 measures the temperature of the cooling air flowing out of the heat exchanger 6. These temperatures are used, in particular by the control unit 17, for determining which operating phase is present, and the valve device 16 is controlled accordingly. The two temperature measuring devices 13 and 14 are thermostats or temperature sensors of per se known type.

1-16. (canceled)

17. A domestic appliance for the care of laundry items, the domestic appliance comprising:
a housing;
a container housed by the housing and operable to accommodate laundry items;
a process air loop communicated with the container and operable to effect a flow of process air through the container;
a heat exchanger communicated with the process air loop and operable to dehumidify process air exiting the container;
a heater communicated with the process air loop and operable to heat process air;
and
a cooling air loop for conveying cooling air from an ambient environment of the domestic appliance into contact with the heat exchanger to thereby cool the heat exchanger, the cooling air loop including an air channeling device that is operable to selectively: a) directly vent at least some of the cooling air fed to the heat exchanger from the domestic appliance to the ambient environment and b) channel at least some of the cooling air fed to the heat exchanger into the domestic appliance for passage thereafter out of openings in the domestic appliance to the ambient environment.

18. The domestic appliance as claimed in claim 17, wherein the air channeling device can be set such that, as an additional option, essentially no cooling of the heat exchanger takes place.

19. The domestic appliance as claimed in claim 17, wherein the air channeling device is disposed downstream of the heat exchanger.

20. The domestic appliance as claimed in claim 17, wherein the air channeling device comprises a valve device which is designed to at least partially block or unblock air outlets for channeling the cooling air.

21. The domestic appliance as claimed in claim 20, wherein the air outlets open into a common nodal point at which the valve device is disposed.

22. The domestic appliance as claimed in claim 20, wherein the valve device can be controlled by a control unit.

23. The domestic appliance as claimed in claim 22, wherein the valve device can be controlled on a time- and/or temperature-dependent basis.

24. The domestic appliance as claimed in claim 23 and further comprising a first temperature measuring unit for measuring the temperature of the laundry items, the valve device being controllable as a function of this laundry item temperature.

25. The domestic appliance as claimed in claim 23 and further comprising a second temperature measuring unit for measuring the temperature of the cooling air downstream of the heat exchanger, the valve device being controllable as a function of this cooling air temperature.

26. The domestic appliance as claimed in claim 22, wherein at least one of the temperature measuring units is a temperature sensor or a thermostat.

27. The domestic appliance as claimed in claim 17, wherein the cooling air loop contains a cooling air blower, the air channeling device being disposed adjacent to the cooling air blower.

28. The domestic appliance as claimed in claim 17, wherein the process air loop contains a process air blower.

29. The domestic appliance as claimed in claim 27 and further comprising a drive unit, in particular a motor, which is designed to drive the container, the cooling air blower and the process air blower.

30. A method for channeling cooling air in a domestic appliance for the care of laundry items, comprising a housing wherein are disposed a container for accommodating laundry items, a process air loop which is connected to the container, process air flowing through the container, a heat exchanger which is connected to the process air loop and is designed to dehumidify the process air leaving the container, a heater which is connected to the process air loop and is designed to heat up the process air, and a cooling air loop for conveying cooling air from the ambient environment of the appliance for cooling the heat exchanger, there being disposed in the cooling air loop an air channeling device which can be set such that optionally:
a) at least some of the cooling air fed to the heat exchanger can be vented directly from the domestic appliance to the ambient environment; and
b) at least some of the cooling air fed to the heat exchanger can be channeled into the appliance and returned to the ambient environment through slits in the housing, in which method process air is circulated by the process air loop and heated by means of the heater, and the air channeling device being initially set such that the cooling air fed to the heat exchanger is vented directly from the domestic appliance into the ambient environment, and is then set such that the cooling air fed to the heat exchanger is channeled into the domestic appliance and returned through the slits to the ambient environment, and finally dehumidification is terminated by terminating the heating of the process air.

31. A method for channeling cooling air in a domestic appliance for the care of laundry items, comprising a housing wherein are disposed a container for accommodating laundry items, a process air loop which is connected to the container, process air flowing through the container, a heat exchanger which is connected to the process air loop and is designed to dehumidify the process air leaving the container, a heater which is connected to the process air loop and is designed to heat up the process air, and a cooling air loop for conveying cooling air from the ambient environment of the appliance for cooling the heat exchanger, there being disposed in the cooling air loop an air channeling device which can be set such that optionally:
a) essentially no cooling of the heat exchanger takes place;
b) at least some of the cooling air fed to the heat exchanger can be vented directly from the domestic appliance to the ambient environment; and
c) at least some of the cooling air fed to the heat exchanger can be channeled into the appliance and returned to the ambient environment through slits in the housing, in which method process air is circulated by the process air loop and heated by means of the heater, and the air channeling device being initially set such that for the purpose of heating the appliance no cooling of the heat exchanger takes place, and is then set such that the cooling air fed to the heat exchanger is vented directly from the domestic appliance to the ambient environment, and is subsequently set such that the cooling air fed to the heat exchanger is channeled into the domestic appliance and returned through the slits to the ambient environment, and finally dehumidification is terminated by terminating the heating of the process air.

32. The method as claimed in claim 30, wherein to terminate dehumidification the air channeling device is set such that the cooling air fed to the heat exchanger is vented directly from the domestic appliance into the ambient environment.
